(19) United States
(12) Patent Application Publication
(10) Pub. No.: US 2017/0185650 A1
(43) Pub. Date: Jun. 29, 2017

(54) Contextual based notification management system for wearable devices

(71) Applicant: Intel Corporation, Santa Clara, CA (US)

(72) Inventors: Oded Vainas, Petah Tiqwa (IL); Tal Marian, Tel Aviv (IL); Ronen Soffer, Tel Aviv (IL)

(21) Appl. No.: 14/757,887

(22) Filed: Dec. 24, 2015

(51) Int. Cl. G06F 17/30; H04L 29/08; G06F 9/54; H04B 1/3827

(52) U.S. Cl. CPC G06F 17/30528; H04B 1/385; H04L 67/26; G06F 9/542

(57) ABSTRACT

One embodiment relates to an apparatus, comprising logic, at least partially incorporated into hardware, to receive a plurality of notifications from each of a plurality of notification sources, determine a ranking score for each notification relative to any other notification received from the same notification source, and determine a notification class for each ranked notification relative to the ranked notifications from all notification sources based upon at least one blending attribute and at least one user contextual state.

### TECHNICAL FIELD

This application relates to the field of computing, and more particularly to contextual based notification management system for wearable devices.

### BACKGROUND

With the emergence of social networks and applications (e.g. Facebook™, WhatsApp, etc.) and online content providers and applications, users are exposed to an intense amount of information being pushed as notifications to their mobile phones and desktops. Moreover, as wearable technology is emerging, those notifications are also being pushed to wearable electronic devices, such as smart watches and smart eyewear. These notifications may vary in their relevance and priority to the user, but are not necessarily pushed in a preferred or useful way to the user given the user's contextual state and behavioural pattern. Some of the applications sending the notifications may be even regarded as intrusive to the user. In addition, a large number of notifications results in distraction and information overflow to the user. Such a situation may result in low tolerance to the sending application or use of the wearable electronic device by the user. On wearable electronic devices, this behaviour may worsen the user experience as notifications are become more intrusive and the “real estate” of the user interface cannot conveniently display all of the received information. In many applications and underlining operating systems, there are manual configuration settings which allow a user to set whether an application will push a notification at a particular time. A disadvantage of such a system is that the user may lose relevant and important information by not receiving a particular notification if the manual configuration settings block the notification.

### BRIEF DESCRIPTION OF THE DRAWINGS

Embodiments are illustrated by way of example and not limitation in the figures of the accompanying drawings, in which like references indicate similar elements and in which:

FIG. 1 illustrates a communication system 10 for contextual based notification management for wearable electronic devices;

FIG. 2 illustrates an embodiment of a wearable electronic device of the communication system of FIG. 1;

FIG. 3 illustrates a functional block diagram showing example operations associated with the wearable electronic device according to one embodiment; and

FIG. 4 is simplified flow diagram illustrating example operations associated with contextual based notification management for the wearable electronic device in accordance with one embodiment.

### DETAILED DESCRIPTION OF EXAMPLE EMBODIMENTS

One or more example embodiments are directed to automatic contextual and semantic based notification management for notifications pushed to wearable devices. One or more embodiments provide for one or more of: (1) automatic learning and adjustment over time of user interactions with different notification sources given the user contextual state or the time of the notification; (2) ranking, prioritization and determination of a correct contextual timing for presenting the user with each incoming notification; (3) deciding on the intrusiveness level of each notification; and (4) collecting user actions and using the user actions as a feedback to a learning process for notification. In one or more embodiments, a contextual time or state may refer to a semantic representation of time or state. For example, in certain embodiments instead of representing a contextual time as 12:45 pm, a user may have a semantic representation of contextual state of “at work”, “while driving”, etc.

In one example scenario, a user may always choose to answer text messages received from a spouse. Hence, while the user is in a meeting at work, text messages from a spouse may be pushed to a wearable device associated with the user immediately, whereas messages from other sources and/or contacts may be placed in a queue to allow notification to the user at a later time. In another example scenario, a user that is currently exercising may receive a Facebook™ notification by the wearable device. For that user, the wearable device may have previously learned that Facebook™ notifications are read when the user is free (e.g., having a contextual semantic time state of “free”). During the exercising contextual state, Facebook™ notifications are queued by the wearable device. When the wearable device identifies the end of the exercise contextual state, the wearable device pushes the queued Facebook™ notifications to the user. In another example scenario, when a user is commuting to work and a semantic and contextual time and state of “commuting” is identified by the wearable device, emails from the previous night are push to the user by the smart device (e.g., eyewear or a watch).

Some existing notification management systems in mobile operation systems, such as Android or iOS, include specific modules or operational modes when connected to wearable devices that depend upon static settings controlled by the user through a configuration user interface. In contrast, various embodiments described herein incorporate a user's interaction history with an understanding of the user's contextual and semantic states to determine whether particular notifications are to be pushed to the user of the wearable device.

In one or more embodiments, the wearable device include several main modules to provide algorithms for notification management for the wearable device:

1. A learning and ranking algorithm module for notifications per source which takes into account multiple attributes of each notification, including type, sender, content, context, user past interaction, etc.

2. A blending algorithm module which ranks together different results of each notification source obtained from the learning and ranking algorithm module.

3. A priority queue manager which controls a cycle of re-ranking and inputting the user's contextual state changes, and outputs final ranked notifications. In some embodiments, may incorporate real life policies that overrule the algorithm results.

4. A user state module that collects information on the contextual and semantic attributes of the user. Those attributes may be used in the different algorithmic layers and be used as triggers to the notifications ranking.

In various embodiments, the system takes into account a user's pre-configured settings to as an input to the automatic learning process to maintain a good user experience. In various embodiments, the automatic process is adjustable and learns new user behaviour(s) over time. In terms of user experience, in one or more embodiments the system may define several priority categories which can be easily translated into available alerting modality options in the wearable device. For example, in a particular embodiment the highest priority notification is translated into sound and/or vibration alerts whereas a lower priority notifications is translated into an LED or other visual alert.

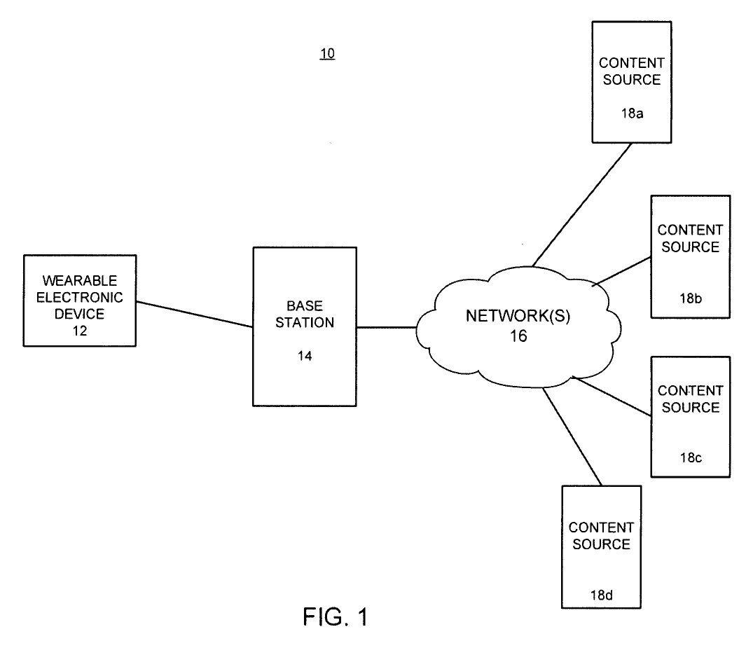

FIG. 1 illustrates a communication system 10 for contextual based notification management for wearable electronic devices. In the particular embodiment illustrated in FIG. 1, communication system 10 includes a wearable electronic device 12, a base station 14, one or more communication networks 16, a first content source 18a, a second content source 18b, a third content source 18c, and a fourth content source 18d. Wearable electronic device 12 is in wireless communication with base station 14, and base station 14 is in communication with communication network(s) 16. Each of first content source 18a, second content source 18b, third content source 18c, and fourth content source 18d are in communication with communication network(s) 16.

In one or more embodiments, wearable electronic device 12 is a communication and/or computing device that is designed to be worn by a user and configured to receive content transmitted by one or more content providers and/or content sources such as one or more of content sources 18a-18d. In particular embodiments, wearable electronic device 12 may include one or more of a smart watch, a fitness and/or activity tracker, a health monitor, a navigation device, a media playback device, a smart phone, ‘smart jewelry, smart glasses, a head-mounted optical display, an ear-bud or any other suitable wearable electronic device.

Base station 14 includes a transceiver configured to wirelessly communicate with wearable electronic device 12 and facilitate communication of wearable electronic device 12 with network(s) 16. In particular embodiments, base station 14 may include one or more of a cellular base station such as a Long-Term Evolution (LTE) eNodeB, a 3G base station, a WiFi base station, a small cell base station, or any other suitable base station. Although the illustrated embodiment describes the wearable electronic device as communicating directly with base station 14, it should be understood that in some embodiments wearable electronic device 12 may communicate with base station 14 via an intermediary communication device such as a smart phone. In accordance with various embodiments, communication network(s) 16 may include one or more of a cellular network, a wireless network, a wired network, the Internet, a local area network (LAN), a wide area network (WAN), a private network, an enterprise network, a Wi-Fi network or any other suitable communication network.

In one or more embodiments, each of content sources 18a-18d include one or more servers, entities, or content providers that are configured to provide content to wearable electronic device 12 in which the receipt of such content may trigger a potential notification of the receipt by wearable electronic device 12. In one or more embodiments, the wearable electronic device 12 includes one or more content applications associated with a particular type of content. In particular embodiments, each of the content applications is configured to function as a notification source generate a potential notification in response to receipt of a particular type of content from one or more of content sources 18a-18d. Examples of content that may be received by wearable electronic device 12 from one or more of content sources 18a-18d in various embodiments includes incoming phone calls, text messages, e-mails, social media updates, news updates, personal assistant updates, calendar updates, instant messages, or any other type of content. In accordance with various embodiments as further described herein, wearable electronic device 12 is configured to provide notification management functions upon received content to determine whether a particular notification will be provided to a user of the wearable electronic device 12 at a particular contextual time or state of the user.

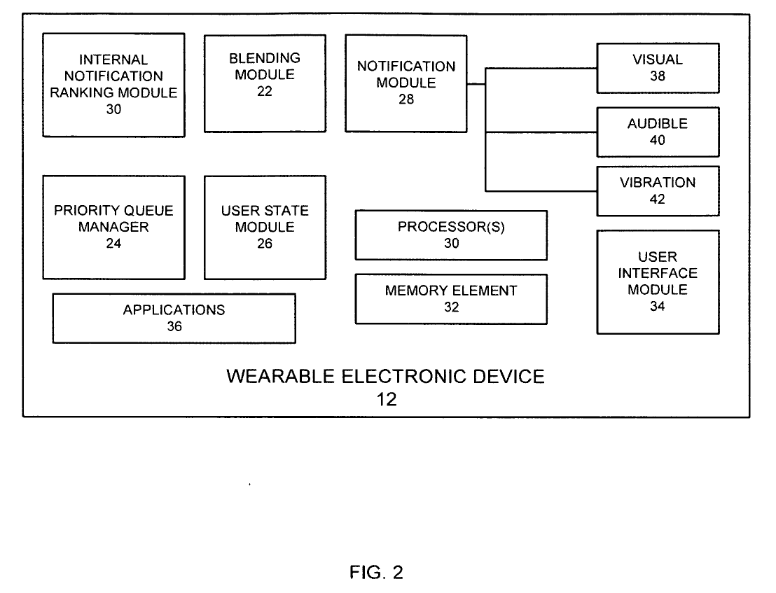

FIG. 2 illustrates an embodiment of wearable electronic device 12 of the communication system 10 of FIG. 1. In the particular embodiment illustrated in FIG. 2, wearable electronic device 12 includes a internal notification ranking module 20, a blending module 22, a priority queue manager 24, a user state module 26, one or more processor(s) 30, a memory element 32, a user interface module 34, one or more content applications 36, a visual notification device 38, an audible notification device 40, and a vibration notification device 42.

Internal notification ranking module 20 includes a ranking algorithm for each notification source that automatically learns a priority between notifications received from the notification source. The ranking algorithm for each source considers notification attributes for each notification to determine a ranking score of each notification in relation to the other notifications from the notification source. In particular embodiments, the notification attributes for each may source that may be considered by the ranking algorithm to determine the ranking of received notifications includes, but is not limited to:
a. Content of the notification based on textual and/or natural language techniques.
b. Sender Identity when available; in content applications such as news applications the sender identity may be content dependent.
c. Contextual user state and semantic time such as driving, exercising, in a meeting, at home, arriving to work, etc.
d. User actions stored in a history.
e. User interactions with previous notifications.
f. Device status of the wearable electronic device 12 such as battery state, charging, stationary, muted, connected to 3G/LTE/WiFi.

In accordance with one or more embodiments, the ranking algorithm will be invoked each time one more incoming notifications is pushed by a notification source to internal notification ranking module 20 in order to rank the notification(s). Internal notification ranking module 20 then outputs the notification to blending module 22.

Blending module 22 includes a source type blending algorithm that receives the different notifications and respective ranking scores associated with each notification from the internal notification ranking module 20 and ranks the different notification sources according to one or more blending attributes. In one or more embodiments, the blending algorithm is invoked each time the user's contextual state changes, which in turn affects the rank of the different notifications. In particular embodiments, the blending module 22 may consider, but is not limited to, one or more of the following blending attributes:
a. Notification Source
b. Notification type
   i. Calls (VOIP calls, e.g. WhatsApp Messenger, Phone calls, etc.)
   ii. Instant messaging (e.g. SMS, WhatsApp Messenger, etc.)
   iii. Non-instant messaging (e.g. e-mails)
   iv. Content and ephemeral information (e.g. news notifications)
   v. Reminders
c. Contextual user state and semantic time (e.g., driving, exercising, in a meeting, at home, etc.)
d. User actions in history
e. User interactions with notifications
f. Device status of wearable electronic device 12 (e.g., battery state, charging, stationary, muted, connected to 3G/LTE/WiFi)

In particular embodiments, the blending algorithm classifies each notification into one of several notification classes based on priority and intrusiveness level (in ascending order):
a. Low Priority—e.g., do not show notification
b. Medium Priority—e.g., show notifications on the next interaction with the device (notification waits on screen, e.g. the user will see the notification when he interacts with the device)
c. High Priority—e.g., Show notification when the device is activated but the user is not interacting with it (e.g. user looks at the device when the displayed is turned off, but can see an alert on the notification with and LED, for instance)
d. Urgent Priority—Show notification even when the device is Idle and uses the highest attention alerting modalities (e.g. Led+Vibrations).

Although in the illustrated embodiment internal notification ranking module 20 and blending module 22 are shown as separate modules, it should be understood that in other embodiments the internal notifications ranking algorithm performed by internal notification ranking module 20 and the source type blending algorithm performed by blending module 22 may be embodied as a single module and/or algorithm.

Priority queue manager 24 is configured to maintain a priority queue into which the blending module 22 outputs the blended notifications and determines whether a notification is to be presented to a user based upon the priority/notification class of a particular notification and/or a context state of the user. In one or more embodiments, the priority queue manager 24 is invoked each time a new notification arrives or is dismissed and/or when the user context state is changed. In various embodiments, when a particular notification is interacted with by the user, the notification is removed from the queue. In particular embodiments, priority queue manager 24 may be configured to include a policy that can overrule the rank of the blending algorithm model based upon particular conditions.

User state module 26 is configured to store the different contextual and semantic states of a user, e.g. driving, exercising, in a meeting, at home, etc. In one or more embodiments, user state module 26 receives information used to determine the contextual and/or semantic state of the user from external information sources. In one or more embodiments, the contextual state is determined or inferred by sensorial information from the device itself, a secondary device (e.g. smart phone) connected to wearable electronic device 12, a plurality of devices that generate sensor data from which context can be determined or inferred (e.g. a user having a smart watch and smart glasses connected together or via a centralized server) or any external context provider (e.g. calendar, weather reports, etc.). In various embodiments, user state module 26 may be subscribed to by other modules and/or components of wearable electronic device 12 such as internal notification ranking module 20, blending module 22, and priority queue manager 24 to provide information regarding the user's contextual and/or semantic state to these modules/components. In one or more embodiments, each time a user's state has changed, user state module 26 sends a callback indicative of the new user state to the subscriber listeners such as one or more of internal notification ranking module 20, blending module 22, and priority queue manager 24.

Notification module is configured to provide one or more ranked and blended notifications to the user via one or more notification devices based upon the classification of the particular notification such as one or more of visual notification device 38, audible notification device 40, and vibration notification device 42. In a particular embodiment, visual notification device 38 may include an LED or on-screen display configured to provide visual indication to the user of the notification. In another particular embodiment, audible notification device 40 may include a speaker configured to provide an audible indication to the user of a notification. In still another particular embodiment, vibration notification device 42 may include a vibration device configured to generate a vibration to the user to provide an indication of a notification.

Processor(s) 30 is configured to execute software instructions to perform various operations of wearable electronic device 12 as described herein. Processor(s) 30 may be any type of processor, such as a micro-processor, an embedded processor, a digital signal processor (DSP), a network processor, or other device to execute code. Although only one processor(s) 30 is illustrated in FIG. 2, it should be understood that wearable electronic device 12 may include more than one processor in some embodiments. Memory element 32 may be configured to store software instructions and data associated with wearable electronic device 12. Memory element 12 may be any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 10 could be provided in any database, register, queue, table, cache, control list, or other storage structure, all of which can be referenced at any suitable timeframe. Any such storage options may also be included within the broad term ‘memory element’ as used herein.

User interface module 34 is configured to provide an interface to the user to allow user configuration and management of notifications. In particular embodiments, the user interface provided by user interface module 34 may include one or more of a graphical user interface, a button, a switch, a touch screen, a touchpad, or any other suitable user interface device. On one or more embodiments, user interface module 34 may allow a user to decide if the notification system provide by wearable electronic device 12 is to be configured manually by the user or whether the user will opt in for an automatic learning option for notification management. In particular embodiments, if the user chose the automatic learning option, the user can utilize the user interface to override settings of the automatic learning option. In other particular embodiments, user interface module 34 may present the user with one or more options of notifications intrusiveness and assign an alerting modality to each priority/notification class (e.g. loud sound and vibrations, LED, no alerting, etc.).

Content applications 36 include one or more applications that are each configured to function as a notification source by providing notifications to internal notification ranking module 20. In particular embodiments, content applications may include one or more of an incoming phone call application, a text message application, an e-mail application, a social media application, a news application, a personal assistant, a calendar application, an instant message application, or any other type of application configured to provide a notification of content to the user. In particular embodiments, one or more of the content applications 36 may be either installed by the user of wearable electronic device 12 or be pre-installed on the wearable electronic device 12.

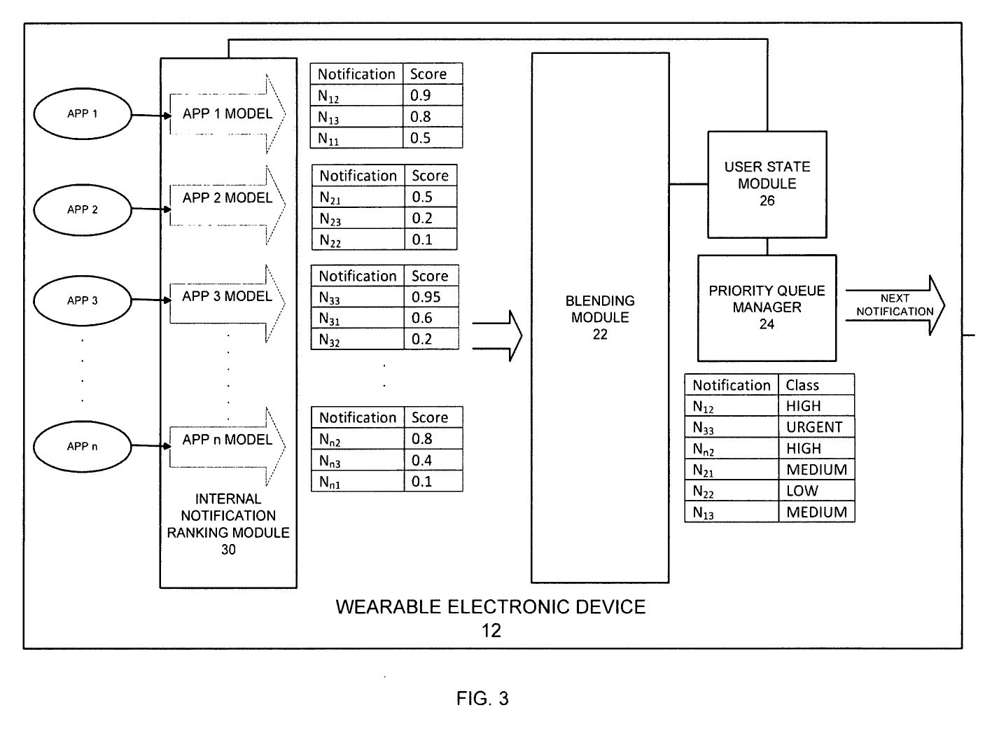

FIG. 3 illustrates a functional block diagram showing example operations associated with wearable electronic device 12 according to one embodiment. In the embodiment illustrated in FIG. 3, wearable electronic device 12 includes a number of content applications 36a-36n installed therein. In particular embodiments, each of the content applications 36a-36n is configured to function as a notification source to generate a notification in response to receipt of a particular type of content from one or more of content sources and send the notification to internal notification ranking module 20. Internal notification ranking module 20 is configured to execute an internal notification ranking algorithm upon the notification utilizing an application ranking model associated with each content application. The application ranking model is configured to rank each notification received from the particular content application in relation to the other notifications received from the particular content application. For example, a notification Nᵢⱼ may be representative of the j-th notification received from the i-th content application.

In the particular embodiment illustrated in FIG. 3, internal notification ranking module 20 includes a first application ranking model (APP 1 Model) configured to rank notifications received from a first content application (APP 1), a second application ranking model (APP 2 Model) configured to rank notifications received from a second content application (APP 2), a third application ranking model (APP 3 Model) configured to rank notifications received from a third content application (APP 3) up to an n-th application ranking model (APP n Model) configured to rank notifications received from an n-th content application (APP n). In the particular example of FIG. 1, APP 1 Model receives notifications from APP 1 and calculates a ranking score for a notification N₁₂ of 0.9, a ranking score for a notification N₁₃ of 0.8, and a ranking score for a notification N₁₁ of 0.5. APP 2 Model receives notifications from APP 2 and calculates a ranking score for a notification N₂₁ of 0.2, a ranking score for a notification N₂₃ of 0.2, and a ranking score for a notification N₂₂ of 0.1. APP 3 Model receives notifications from APP 3 and calculates a ranking score for a notification N₃₃ of 0.95, a ranking score for a notification N₃₁ of 0.6, and a ranking score for a notification N₃₂ of 0.2. APP n Model receives notifications from APP n and calculates a ranking score for a notification Nₙ₂ of 0.8, a ranking score for a notification Nₙ₃ of 0.4, and a ranking score for a notification Nₙ₁ of 0.1

Blending module 22 is configured to receive the ranked notifications and ranking scores from each of APP 1 Model, App 2 Model, App 3 Model up to App n Model, execute a source type blending algorithm, rank the different notifications according to their associated rank scores and one or more blending attributes, and classify each notifications into a notification class. In accordance with various embodiments, the one or more blending attributes may include the notification source (e.g., the particular content application associated with the notification), notification type (e.g., calls (VOIP calls, instant messaging, e-mails, news, reminders), contextual user state and semantic time (e.g., driving, exercising, in a meeting, at home, etc.), user actions in history, user interactions with prior notifications, and device status. In one or more embodiments, the blending algorithm is invoked each time the user's contextual state changes. In a particular embodiment, blending module 22 classifies each notification into one of several notification classes: low priority, medium priority, high priority, and urgent priority. In the example of FIG. 3, notification N₁₂ is classified as high priority, notification N₃₃ is classified as urgent priority, notification Nₙ₂ is classified as urgent priority, notification N₂₁ is classified as medium priority, notification N₂₂ is classified as low priority, and notification N₁₃ is classified as medium priority. Although in the illustrated embodiment internal notification ranking module 20 and blending module 22 are shown as separate modules, it should be understood that in other embodiments the internal notifications ranking algorithm performed by internal notification ranking module 20 and the source type blending algorithm performed by blending module 22 may be embodied as a single module and/or algorithm.

Priority queue manager 24 is to maintain a priority queue into which the blending module 22 outputs the blended notifications and determines whether a particular notification is to be presented to a user based upon the classification of a particular notification and/or a context state of the user. If the conditions are met to output a particular notification, priority queue manager 24 outputs the particular notification from the queue to notify the user according to the classification of the notification and/or setting of the user. For example, for a particular contextual state of the user, a notification having a low classification may not be shown to the user at all, a notification having a medium classification may be shown to the user upon the user's next interaction with the wearable electronic device 12, a notification having a high classification may be shown to the user when the wearable electronic device 12 is activated but the user is not interacting with it, and a notification having an urgent classification may be shown to the user even when the wearable electronic device 12 is idle and use the highest attention alerting modalities (e.g. LED and vibrations).

User state module 26 is configured to store the different contextual and semantic states of a user, e.g. driving, exercising, in a meeting, at home, etc. In one or more embodiments, user state module 26 receives information used to determine the contextual and/or semantic state of the user from external information sources. In various embodiments, user state module 26 may be subscribed to by internal notification ranking module 20, blending module 22, and priority queue manager 24 to provide information regarding the user's contextual and/or semantic state to these modules/components. Accordingly, one or more of internal notification ranking module 20, blending module 22, and priority queue manager 24 may utilize the user's contextual and/or semantic state to perform their respective ranking, blending, and notification queuing operations. In one or more embodiments, each time a user's state has changed, user state module 26 sends a callback indicative of the new user state to internal notification ranking module 20, blending module 22, and priority queue manager 24.

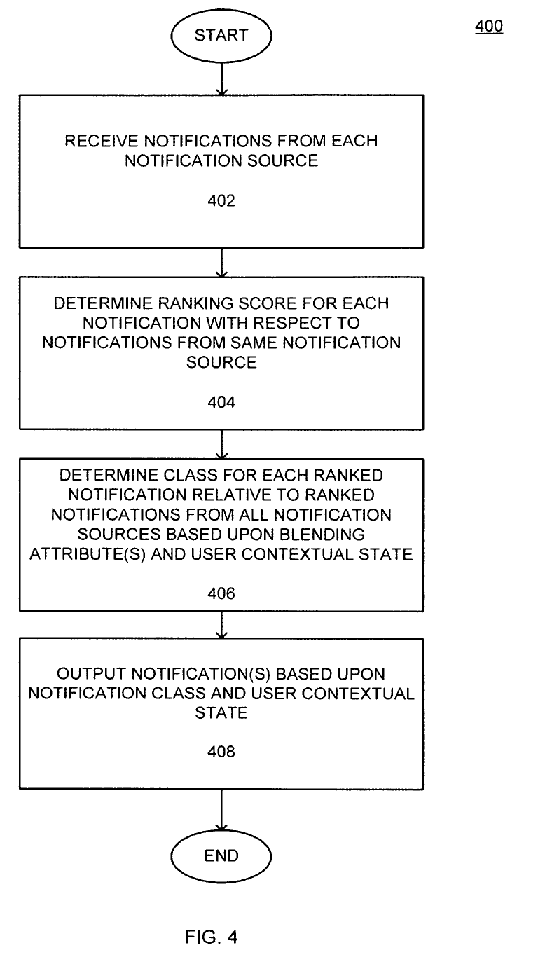

FIG. 4 is simplified flow diagram 400 illustrating example operations associated with contextual based notification management for wearable electronic device 12 in accordance with one embodiment. In 402, internal notification ranking module 402 of wearable electronic device 12 receives a plurality of notifications from each of a plurality of notification sources. In particular embodiments, each of the plurality of notifications sources includes one or more of content applications 36a-36n. In 404, internal notification ranking module 402 determines a ranking score for each notification relative to the notifications received from the same notification source. Accordingly, each notification for a particular notification source is ranked relative to the other notifications from the same notification source. In one or more embodiments, internal notification ranking module 402 utilizes one or more notification attributes associated with each notification to determine a ranking score of each notification in relation to the other notifications received from the notification source. In accordance with various embodiments, the one or more notification attributes include at least one of content of the notification, a sender identity associated with the notification, the user contextual state, a history of user interactions with previous notifications, and a device status of wearable electronic device 12.

In 406, blending module 22 determines a notification class for each ranked notification relative to the ranked notifications from all notification sources based upon one or more blending attributes and a user contextual state. In particular embodiments, the one or more blending attributes include the notification source, a notification type, historical user actions with respect to the notification source, user interactions with previous notifications, and a device status of wearable electronic device 12. In particular embodiments, the determining of the notification class for each ranked notification is performed responsive to a change in the user contextual state. In 408, wearable electronic device 12 outputs one or more of the notifications based upon the determined notification class for the notification and the user contextual state. In particular embodiments, at least one alerting modality is assigned to each notification class and the notification is output utilizing the assigned at least one alerting modality. The operations then end.

In regards to the internal structure associated with communication system 10, each of wearable electronic device 12, base station 14, and content sources 18a-18d can include memory elements for storing information to be used in the operations outlined herein. Each of wearable electronic device 12, base station 14, and content sources 18a-18d may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 10 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 10, such as wearable electronic device 12, base station 14, and content sources 18a-18d, may include software modules to achieve, or to foster, operations as outlined herein. These modules may be suitably combined in any appropriate manner, which may be based on particular configuration and/or provisioning needs. In certain embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of wearable electronic device 12, base station 14, and content sources 18a-18d may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

One or more embodiments described herein may provide one or more advantages of decreasing the amount of intrusiveness of notifications and increasing the relevance of notifications provided by wearable electronic device resulting in an improved user experience.

### EXAMPLES

The following examples pertain to further embodiments.

Example 1 is an apparatus, comprising logic, at least partially incorporated into hardware, to receive a plurality of notifications from each of a plurality of notification sources; determine a ranking score for each notification relative to any other notification received from the same notification source; and determine a notification class for each ranked notification relative to the ranked notifications from all notification sources based upon at least one blending attribute and at least one user contextual state.

In Example 2, the subject matter of Example 1 can optionally include wherein the logic is further to output one or more of the notifications based upon the determined notification class for the notification and the user contextual state.

In Example 3, the subject matter of Example 2 can optionally include wherein the logic is further to assign at least one alerting modality is assigned to each notification class, wherein the notification is output utilizing the assigned at least one alerting modality.

In Example 4, the subject matter of Example 1 can optionally include wherein the logic is further to utilize one or more notification attributes associated with each notification to determine the ranking score of each notification relative to the notifications received from the notification source.

In Example 5, the subject matter of Example 4 can optionally include wherein the one or more notification attributes includes the user contextual state.

In Example 6, the subject matter of Example 4 can optionally include wherein the one or more notification attributes includes at least one of content of the notification, a sender identity associated with the notification, a history of user interactions with previous notifications, and a device status.

In Example 7, the subject matter of Example 1 can optionally include wherein the one or more blending attributes include the notification source, a notification type, historical user actions with respect to the notification source, user interactions with previous notifications, and a device status.

In Example 8, the subject matter of Example 1 can optionally include wherein the notification class includes one of a low priority, a medium priority, a high priority, and an urgent priority.

In Example 9, the subject matter of Example 1 can optionally include wherein the determining of the notification class for each ranked notification is performed responsive to a change in the user contextual state.

Example 10 is at least one non-transitory computer storage medium to store computer code comprising: computer code to receive a plurality of notifications from each of a plurality of notification sources; computer code to determine a ranking score for each notification relative to any other notification received from the same notification source; and computer code to determine a notification class for each ranked notification relative to the ranked notifications from all notification sources based upon at least one blending attribute and at least one user contextual state.

In Example 11, the subject matter of Example 10 can optionally include computer code to output one or more of the notifications based upon the determined notification class for the notification and the user contextual state.

In Example 12, the subject matter of Example 11 can optionally include comprising computer code for assigning at least one alerting modality is assigned to each notification class, wherein the notification is output utilizing the assigned at least one alerting modality.

In Example 13, the subject matter of Example 10 can optionally include comprising computer code for utilizing one or more notification attributes associated with each notification to determine the ranking score of each notification relative to the notifications received from the notification source.

In Example 14, the subject matter of Example 13 can optionally include wherein the one or more notification attributes includes the user contextual state.

In Example 15, the subject matter of Example 13 can optionally include wherein the one or more notification attributes includes at least one of content of the notification, a sender identity associated with the notification, a history of user interactions with previous notifications, and a device status.

In Example 16, the subject matter of Example 10 can optionally include wherein the one or more blending attributes include the notification source, a notification type, historical user actions with respect to the notification source, user interactions with previous notifications, and a device status.

In Example 17, the subject matter of Example 10 can optionally include wherein the notification class includes one of a low priority, a medium priority, a high priority, and an urgent priority.

In Example 18, the subject matter of Example 10 can optionally include wherein the determining of the notification class for each ranked notification is performed responsive to a change in the user contextual state.

Example 20 is a computer-implemented method comprising: receiving a plurality of notifications from each of a plurality of notification sources; determining a ranking score for each notification relative to any other notification received from the same notification source; and determining a notification class for each ranked notification relative to the ranked notifications from all notification sources based upon at least one blending attribute and at least one user contextual state.

In Example 21, the subject matter of Example 20 can optionally include outputting one or more of the notifications based upon the determined notification class for the notification and the user contextual state.

In Example 22, the subject matter of Example 21 can optionally include assigning at least one alerting modality is assigned to each notification class, wherein the notification is output utilizing the assigned at least one alerting modality.

In Example 23, the subject matter of Example 20 can optionally include utilizing one or more notification attributes associated with each notification to determine the ranking score of each notification relative to the notifications received from the notification source.

In Example 24, the subject matter of Example 20 can optionally include wherein the determining of the notification class for each ranked notification is performed responsive to a change in the user contextual state.

Example 25 is an apparatus, comprising logic, at least partially incorporated into hardware, to: receive a plurality of notifications from each of a plurality of notification sources; determine a ranking score for each notification relative to any other notification received from the same notification source; and determine a notification class for each ranked notification relative to the ranked notifications from all notification sources based upon at least one blending attribute and at least one user contextual state.

In Example 26, the subject matter of Example 25 can optionally include wherein the logic is further to output one or more of the notifications based upon the determined notification class for the notification and the user contextual state.

In Example 27, the subject matter of Example 25 can optionally include wherein the logic is further to assign at least one alerting modality is assigned to each notification class, wherein the notification is output utilizing the assigned at least one alerting modality.

In Example 28, the subject matter of any one of Examples 25 and 26 can optionally include wherein the logic is further to utilize one or more notification attributes associated with each notification to determine the ranking score of each notification relative to the notifications received from the notification source.

In Example 29, the subject matter of any Example 28 can optionally include wherein the one or more notification attributes includes the user contextual state.

In Example 30, the subject matter of Example 28 can optionally include wherein the one or more notification attributes includes at least one of content of the notification, a sender identity associated with the notification, a history of user interactions with previous notifications, and a device status.

In Example 31, the subject matter of any one of Examples 25 and 26 can optionally include wherein the one or more blending attributes include the notification source, a notification type, historical user actions with respect to the notification source, user interactions with previous notifications, and a device status.

In Example 32, the subject matter of any one of Examples 25 and 26 can optionally include wherein the notification class includes one of a low priority, a medium priority, a high priority, and an urgent priority.

In Example 33, the subject matter of any one of Examples 25 and 26 can optionally include wherein the determining of the notification class for each ranked notification is performed responsive to a change in the user contextual state.

Example 34 is at least one non-transitory computer storage medium to store computer code comprising: computer code to receive a plurality of notifications from each of a plurality of notification sources; computer code to determine a ranking score for each notification relative to any other notification received from the same notification source; and computer code to determine a notification class for each ranked notification relative to the ranked notifications from all notification sources based upon at least one blending attribute and at least one user contextual state.

In Example 35, the subject matter of Example 34 can optionally include computer code to output one or more of the notifications based upon the determined notification class for the notification and the user contextual state.

In Example 36, the subject matter of Example 35 can optionally include computer code for assigning at least one alerting modality is assigned to each notification class, wherein the notification is output utilizing the assigned at least one alerting modality.

In Example 37, the subject matter of any one of Examples 34 and 35 can optionally include computer code for utilizing one or more notification attributes associated with each notification to determine the ranking score of each notification relative to the notifications received from the notification source.

In Example 38, the subject matter of Example 37 can optionally include wherein the one or more notification attributes includes the user contextual state.

In Example 39, the subject matter of any one of Example 37 can optionally include wherein the one or more notification attributes includes at least one of content of the notification, a sender identity associated with the notification, a history of user interactions with previous notifications, and a device status.

In Example 40, the subject matter of any one of Examples 34 and 35 can optionally include wherein the one or more blending attributes include the notification source, a notification type, historical user actions with respect to the notification source, user interactions with previous notifications, and a device status.

In Example 41, the subject matter of any one of Examples 34 and 35 can optionally include wherein the notification class includes one of a low priority, a medium priority, a high priority, and an urgent priority.

In Example 42, the subject matter of any one of Examples 34 and 35 can optionally include wherein the determining of the notification class for each ranked notification is performed responsive to a change in the user contextual state.

Example 43 is a computer-implemented method comprising: receiving a plurality of notifications from each of a Plurality of notification sources; determining a ranking score for each notification relative to any other notification received from the same notification source; and determining a notification class for each ranked notification relative to the ranked notifications from all notification sources based upon at least one blending attribute and at least one user contextual state.

In Example 44, the subject matter of Example 43 can optionally include outputting one or more of the notifications based upon the determined notification class for the notification and the user contextual state.

In Example 45, the subject matter of Example 44 can optionally include assigning at least one alerting modality is assigned to each notification class, wherein the notification is output utilizing the assigned at least one alerting modality.

In Example 46, the subject matter of any one of Examples 43 and 44 can optionally include utilizing one or more notification attributes associated with each notification to determine the ranking score of each notification relative to the notifications received from the notification source.

In Example 47, the subject matter of any one of Examples 43 and 44 can optionally include wherein the determining of the notification class for each ranked notification is performed responsive to a change in the user contextual state.

Example 48 is an apparatus for notification management, comprising: means for receiving a plurality of notifications from each of a plurality of notification sources; means for determining a ranking score for each notification relative to any other notification received from the same notification source; and means for determining a notification class for each ranked notification relative to the ranked notifications from all notification sources based upon at least one blending attribute and at least one user contextual state.

Example 49 is an apparatus, comprising logic, at least partially incorporated into hardware, to: receive a plurality of notifications from each of a plurality of notification sources; determine a ranking score for each notification relative to any other notification received from the same notification source; and determine a notification class for each ranked notification relative to the ranked notifications from all notification sources based upon at least one blending attribute and at least one user contextual state.

In Example 50, the subject matter of Example 49 can optionally include wherein the logic is further to output one or more of the notifications based upon the determined notification class for the notification and the user contextual state.

In Example 51, the subject matter of Example 50 can optionally include wherein the logic is further to assign at least one alerting modality is assigned to each notification class, wherein the notification is output utilizing the assigned at least one alerting modality.

In Example 52, the subject matter of any one of Examples 50 and 51 can optionally include wherein the logic is further to utilize one or more notification attributes associated with each notification to determine the ranking score of each notification relative to the notifications received from the notification source.

In Example 53, the subject matter of Example 52 can optionally include wherein the one or more notification attributes includes the user contextual state.

In Example 54, the subject matter of Example 52 can optionally include wherein the one or more notification attributes includes at least one of content of the notification, a sender identity associated with the notification, a history of user interactions with previous notifications, and a device status.

In Example 55, the subject matter of any one of Examples 49 and 50 can optionally include wherein the one or more blending attributes include the notification source, a notification type, historical user actions with respect to the notification source, user interactions with previous notifications, and a device status.

In Example 56, the subject matter of any one of Examples 49 and 50 can optionally include wherein the notification class includes one of a low priority, a medium priority, a high priority, and an urgent priority.

In Example 57, the subject matter of any one of Examples 49 and 50 can optionally include wherein the determining of the notification class for each ranked notification is performed responsive to a change in the user contextual state.

Example 58 is a computer-implemented method comprising: receiving a plurality of notifications from each of a plurality of notification sources; determining a ranking score for each notification relative to any other notification received from the same notification source; and determining a notification class for each ranked notification relative to the ranked notifications from all notification sources based upon at least one blending attribute and at least one user contextual state.

In Example 59, the subject matter of Example 58 can optionally include outputting one or more of the notifications based upon the determined notification class for the notification and the user contextual state.

In Example 60, the subject matter of Example 59 can optionally include assigning at least one alerting modality is assigned to each notification class, wherein the notification is output utilizing the assigned at least one alerting modality.

In Example 61, the subject matter of any one of Examples 58 and 59 can optionally include utilizing one or more notification attributes associated with each notification to determine the ranking score of each notification relative to the notifications received from the notification source.

In Example 62, the subject matter of Example 61 can optionally include wherein the one or more notification attributes includes the user contextual state.

In Example 63, the subject matter of Example 61 can optionally include wherein the one or more notification attributes includes at least one of content of the notification, a sender identity associated with the notification, a history of user interactions with previous notifications, and a device status.

In Example 64, the subject matter of any one of Examples 58 and 59 can optionally include wherein the one or more blending attributes include the notification source, a notification type, historical user actions with respect to the notification source, user interactions with previous notifications, and a device status.

In Example 65, the subject matter of any one of Examples 58 and 59 can optionally include wherein the notification class includes one of a low priority, a medium priority, a high priority, and an urgent priority.

In Example 66, the subject matter of any one of Examples 58 and 59 can optionally include wherein the determining of the notification class for each ranked notification is performed responsive to a change in the user contextual state.

Example 67 is a computer-readable storage medium including code, when executed, to cause a machine to perform the method of any one of Examples 58-66.

Example 68 is a computer-implemented method comprising: receiving a plurality of notifications from each of a plurality of notification sources; determining a ranking score for each notification relative to any other notification received from the same notification source; and determining a notification class for each ranked notification relative to the ranked notifications from all notification sources based upon at least one blending attribute and at least one user contextual state.

In Example 69, the subject matter of Example 68 can optionally include outputting one or more of the notifications based upon the determined notification class for the notification and the user contextual state.

In Example 70, the subject matter of Example 69 can optionally include assigning at least one alerting modality is assigned to each notification class, wherein the notification is output utilizing the assigned at least one alerting modality.

In Example 71, the subject matter of any one of Examples 68 and 69 can optionally include utilizing one or more notification attributes associated with each notification to determine the ranking score of each notification relative to the notifications received from the notification source.

In Example 72, the subject matter of Example 71 can optionally include wherein the one or more notification attributes includes the user contextual state.

In Example 73, the subject matter of any one of Examples 68 and 69 can optionally include wherein the one or more notification attributes includes at least one of content of the notification, a sender identity associated with the notification, a history of user interactions with previous notifications, and a device status.

In Example 74, the subject matter of any one of Examples 68 and 69 can optionally include wherein the one or more blending attributes include the notification source, a notification type, historical user actions with respect to the notification source, user interactions with previous notifications, and a device status.

In Example 75, the subject matter of any one of Examples 68 and 69 can optionally include wherein the notification class includes one of a low priority, a medium priority, a high priority, and an urgent priority.

In Example 76, the subject matter of any one of Examples 68 and 69 can optionally include wherein the determining of the notification class for each ranked notification is performed responsive t₉ a change in the user contextual state.

Example 77 is an apparatus comprising means to perform a method of any preceding example.

Example 78 is a machine-readable storage including machine-readable instructions, when executed, to implement a method or realize an apparatus of any preceding example.

What is claimed is:

1. An apparatus, comprising logic, at least partially incorporated into hardware, to:
receive a plurality of notifications from each of a plurality of notification sources;
determine a ranking score for each notification relative to any other notification received from the same notification source; and
determine a notification class for each ranked notification relative to the ranked notifications from all notification sources based upon at least one blending attribute and at least one user contextual state.

2. The apparatus of claim 1, wherein the logic is further to output one or more of the notifications based upon the determined notification class for the notification and the user contextual state.

3. The apparatus of claim 2, wherein the logic is further to assign at least one alerting modality is assigned to each notification class, wherein the notification is output utilizing the assigned at least one alerting modality.

4. The apparatus of claim 1, wherein the logic is further to utilize one or more notification attributes associated with each notification to determine the ranking score of each notification relative to the notifications received from the notification source.

5. The apparatus of claim 4, wherein the one or more notification attributes includes the user contextual state.

6. The apparatus of claim 4, wherein the one or more notification attributes includes at least one of content of the notification, a sender identity associated with the notification, a history of user interactions with previous notifications, and a device status.

7. The apparatus of claim 1, wherein the one or more blending attributes include the notification source, a notification type, historical user actions with respect to the notification source, user interactions with previous notifications, and a device status.

8. The apparatus of claim 1, wherein the notification class includes one of a low priority, a medium priority, a high priority, and an urgent priority.

9. The apparatus of claim 1, wherein the determining of the notification class for each ranked notification is performed responsive to a change in the user contextual state.

10. At least one non-transitory computer storage medium to store computer code comprising:
computer code to receive a plurality of notifications from each of a plurality of notification sources;
computer code to determine a ranking score for each notification relative to any other notification received from the same notification source; and
computer code to determine a notification class for each ranked notification relative to the ranked notifications from all notification sources based upon at least one blending attribute and at least one user contextual state.

11. The at least one non-transitory computer storage medium of claim 10, further comprising computer code to output one or more of the notifications based upon the determined notification class for the notification and the user contextual state.

12. The at least one non-transitory computer storage medium of claim 11, further comprising computer code for assigning at least one alerting modality is assigned to each notification class, wherein the notification is output utilizing the assigned at least one alerting modality.

13. The at least one non-transitory computer storage medium of claim 10, further comprising computer code for utilizing one or more notification attributes associated with each notification to determine the ranking score of each notification relative to the notifications received from the notification source.

14. The at least one non-transitory computer storage medium of claim 13, wherein the one or more notification attributes includes the user contextual state.

15. The at least one non-transitory computer storage medium of claim 13, wherein the one or more notification attributes includes at least one of content of the notification, a sender identity associated with the notification, a history of user interactions with previous notifications, and a device status.

16. The at least one non-transitory computer storage medium of claim 10, wherein the one or more blending attributes include the notification source, a notification type, historical user actions with respect to the notification source, user interactions with previous notifications, and a device status.

17. The at least one non-transitory computer storage medium of claim 10, wherein the notification class includes one of a low priority, a medium priority, a high priority, and an urgent priority.

18. The at least one non-transitory computer storage medium of claim 10, wherein the determining of the notification class for each ranked notification is performed responsive to a change in the user contextual state.

20. A computer-implemented method comprising:
receiving a plurality of notifications from each of a plurality of notification sources;
determining a ranking score for each notification relative to any other notification received from the same notification source; and
determining a notification class for each ranked notification relative to the ranked notifications from all notification sources based upon at least one blending attribute and at least one user contextual state.

21. The computer-implemented method of claim 20, further comprising outputting one or more of the notifications based upon the determined notification class for the notification and the user contextual state.

22. The computer-implemented method of claim 21, further comprising assigning at least one alerting modality is assigned to each notification class, wherein the notification is output utilizing the assigned at least one alerting modality.

23. The computer-implemented method of claim 20, further comprising utilizing one or more notification attributes associated with each notification to determine the ranking score of each notification relative to the notifications received from the notification source.

24. The computer-implemented method of claim 20, wherein the determining of the notification class for each ranked notification is performed responsive to a change in the user contextual state.
